(19) United States
(12) Patent Application Publication
(10) Pub. No.: US 2006/0252360 A1
(43) Pub. Date: Nov. 9, 2006

(54) Aircraft cabin pressurization control apparatus

(76) Inventors: James A. Mitchneck, Lowell, MA (US); Norman White, Bedford, NH (US); Mark Long Whittum, Somerville, MA (US)

Correspondence Address: Law Office of William B. Ritchie, 1411 Northern Heights Drive NE, Rochester, MN, 55906-4045, US

(21) Appl. No.: 11/403,210

(22) Filed: Apr. 12, 2006

Related U.S. Application Data
(60) Provisional application No. 60/671,264, filed on Apr. 14, 2005.

(51) Int. Cl. B64D 13/02

(52) U.S. Cl. 454/74

(57) ABSTRACT

A cabin pressure control apparatus that has an outflow valve that operates with a reference chamber without the need of using bleed air from the aircraft engines to adjust the pressure within the reference chamber. The invention has only pneumatic connections and no electrical connections to the outflow valve. Intrinsic negative differential protection is provided. Control solenoid(s) and pump(s) are internal to the controller for protection and simplified interconnection. The apparatus can be easily fitted in the aircraft without requiring additional cockpit panel space. The aircraft pressurization control apparatus is fully backward compatible with existing pressurization control systems as currently being manufactured by Kollsman, Inc.

### FIELD OF THE INVENTION

This invention relates to aircraft pressurization control systems, in particular, mechanisms which regulate the flow of air from and into the cabin to maintain cabin pressure within prescribed limits.

### BACKGROUND OF THE INVENTION

A number of devices have been proposed which are designed to regulate the cabin pressure of an aircraft as the aircraft ascends and the ambient pressure decreases. Due to the physiological requirements of the passengers, the cabin pressure under any conditions must not be permitted to fall below that what would be experienced by a mountain climber at an altitude of 15,000 feet. Even under those emergency conditions, passengers and crew can experience hypoxia and mountain sickness. Therefore, modern business aircraft have a maximum set cabin altitude of approximately 8,000 feet to maintain a comfortable margin of safety.

Ideally it would be preferable to maintain cabin pressure at or near sea level irrespective of the actual altitude of the aircraft. However, pressure differentials between the cabin and the ambient pressure would require the aircraft to be so robust as to be impractical. Therefore, aircraft manufacturers generally design their craft to have a maximum pressure differential of no more than approximately 8½ to 9½ psi. This design specification enables business jets to operate at reasonable cruise altitudes yet maintain comfortable cabin pressure conditions.

Environmental air conditioning systems using bleed air from the aircraft engines introduce fresh air from the outside so that occupants are comfortable and not breathing the same air over and over again during the flight. Business jet aircraft such as Cessna Citation CJ1, CJ2, Bravo, Encore and Excel Aircraft typically fly at a cruise altitude of about 30,000 feet to 40,000 feet more or less depending on traffic and weather conditions.

Outflow valves such as those made by Kollsman, Inc. of Merrimack, N.H. utilize an internal reference chamber that, in combination with a solenoids and bleed air from aircraft engine(s) to control the reference chamber, pressurizing the aircraft. Depending on the pressure within the reference chamber relative to the cabin pressure and ambient pressure, the outflow valve will either allow air to exit from the cabin faster than the airflow into the cabin (such as required when the aircraft is ascending) or air to exit from the cabin slower than the airflow into the cabin (such as required during descending). While these valves are extremely reliable and enable the aircraft to maintain a comfortable cabin pressure during the operating envelope of the aircraft, the bleed air from the engine typically contains a number of contaminants. This includes, water, iron particles (rust), and petrochemicals. These contaminates can build up over time in the solenoid (the magnetics hold the rust) and cause a fault in the system.

A cabin pressure control apparatus that has an outflow valve that operates with a reference chamber without the need of using bleed air from the aircraft engines to adjust the pressure within the reference chamber; has only pneumatic connections and no electrical connections to the outflow valve; provides intrinsic negative differential protection; has control solenoid(s) and pump(s) that are internal to the controller for protection and simplified interconnection and has been easily fitted in the aircraft without requiring cockpit panel space is not found in the prior art.

### SUMMARY OF THE INVENTION

It is an aspect of the invention to provide an aircraft pressurization control apparatus that will pneumatically regulate the flow of exhaust air from an aircraft cabin.

It is another aspect of the invention to provide an aircraft pressurization control apparatus that provides two or more identical outflow valves.

Another aspect of the invention is to provide an aircraft pressurization control apparatus that utilizes at least one miniature pump that is used to inflate or deflate a reference chamber that is positioned within an outflow valve.

It is still another aspect of the invention to provide an aircraft pressurization control apparatus to incorporate at least one miniature pump within the controller of the aircraft pressurization control apparatus.

Another aspect of the invention is to provide an aircraft pressurization apparatus that uses only pneumatic connections between the outflow valve and the controller.

It is an aspect of the invention to provide an aircraft pressurization control apparatus that has one controller for a pair of two or more identical outflow valves.

Another aspect of the invention is to provide an aircraft pressurization control apparatus that uses one pump and one solenoid to inflate the reference chambers of the respective outflow valves and a vacuum pump and its solenoid to deflate the reference chambers of the respective outflow valves.

It is still another aspect of the invention to provide an aircraft pressurization control apparatus that has the inflation pump and solenoid pneumatically connected to the aircraft cabin and the vacuum pump and its solenoid to the ambient air outside of the aircraft cabin.

It is another aspect of the invention to provide an aircraft pressurization control apparatus that is full backward compatible with the existing pressurization control system manufactured by Kollsman.

Finally, it is aspect of the invention to provide an aircraft pressurization control apparatus that eliminates the need for using bleed air from the aircraft engines in order to operate the reference chambers of the outflow valves of the aircraft pressurization control system.

These and other aspects of the invention will become apparent in light of the detailed description of the invention which follows.

### BRIEF DESCRIPTION OF THE DRAWINGS

FIG. 1 is an illustration of the aircraft pressurization control apparatus in accordance with the invention.

FIG. 2 is an isometric view of the controller of the apparatus.

FIG. 3. is an isometric view of an outflow valve of the apparatus.

FIG. 4 is top view of the controller housing with the cover removed showing the placement of the solenoids and miniature pumps in the preferred embodiment.

FIG. 5 is a cross-sectional view of the outflow valve showing the reference chamber diaphragm.

FIG. 6 is an illustration of the surface area of the diaphragm showing the cabin annular area relative to the ambient annular area.

FIG. 7 is an illustration of the controller pumps and solenoid connections in the preferred embodiment.

FIG. 8 is an illustration of an alternative embodiment for the controller pneumatic connections using only the inflation pump with the solenoids.

FIG. 9 is an illustration of another alternative embodiment showing the use of one reversible pump connected in series to a solenoid on the cabin flow side of the controller mechanism.

FIG. 10 is an illustration of still another alternative embodiment showing the use of one reversible pump connected in series to a solenoid on the ambient air side of the controller mechanism.

FIG. 11 is an illustration of another alternative embodiment showing the use of one reversible pump connected in parallel to a solenoid on the cabin air flow side of the controller mechanism.

FIG. 12 is another illustration of an alternative embodiment using a single vane or centrifugal pump.

FIG. 13 is an illustration of an alternative embodiment using a single reversible pump.

FIG. 14 illustrates an embodiment of the invention using two pumps connected in parallel in order to increase the maximum flow rates.

### DESCRIPTION OF THE PREFERRED EMBODIMENTS

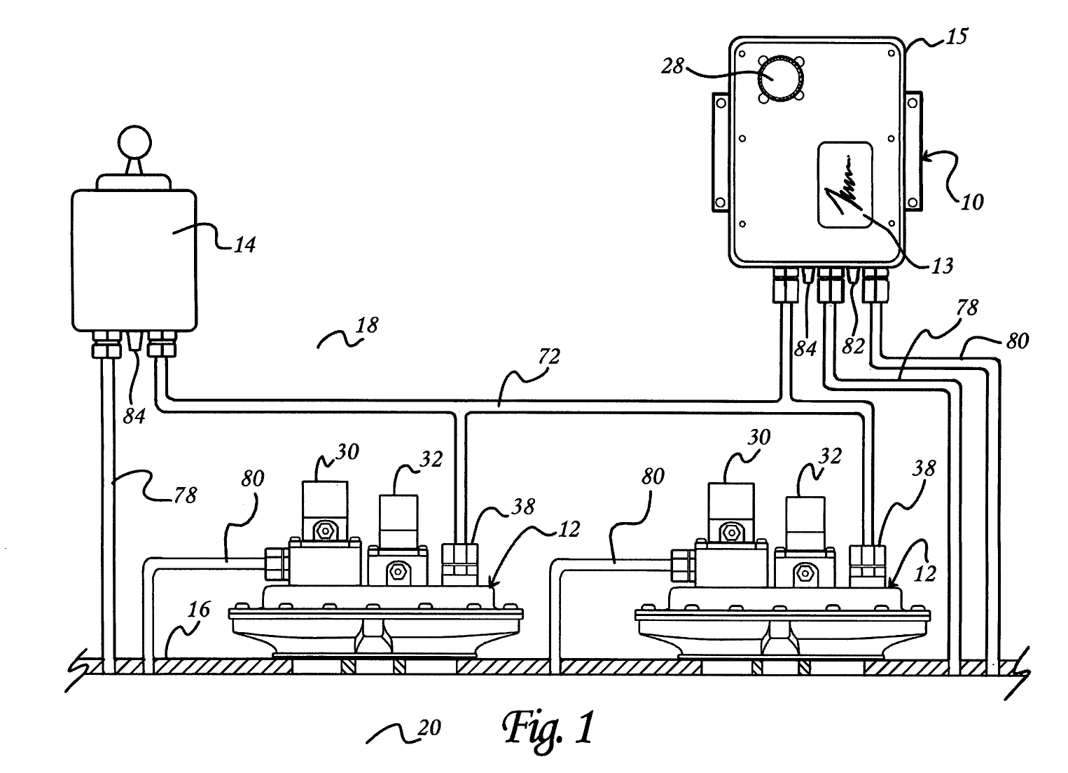

The cabin pressurization control apparatus includes two identical outflow valves 12 as shown in FIG. 1. Valves 12 pneumatically regulate the flow of exhaust air from the cabin 18, and require no electrical power to operate. Each self-regulating outflow valve is constructed with a reinforced fluorosilicone diaphragm covering an outlet grill. The diaphragm is larger than the grill by an amount that makes the annular area approximately equal to the grill area. Cabin pressure pushes against the annular outer area of the diaphragm, trying to open the outflow port. The lower pressure outside the aircraft structure draws the diaphragm against the grill trying to close the port.

Above the diaphragm is a sealed reference pressure chamber. The air trapped in this chamber functions as the regulating “spring” which determines the operating point of the valve. The KAPS II controller contains two Solenoid pilot valves that are driven by the controller electronics to change the reference chamber pressure. These solenoids connect either cabin air or outside static air to the reference chamber to change its internal pressure. Changes in reference chamber pressure cause the diaphragm to move, which either increases or decreases the outflow rate from the cabin, thereby changing the cabin pressure and equivalent altitude. A common pneumatic connection between outflow valve reference chambers ensures balanced outflow between valves.

The valve geometry is such that the pressure in the reference chamber always lies midway between the cabin air pressure and the ambient static air pressure. During flight, the static air outside the aircraft is at a lower pressure than the air in the aircraft cabin. This allows the reference chamber to be inflated by the cabin pressure regulated by a solenoid and deflated by using ambient pressure regulated by a solenoid. When the aircraft is on the ground, there is almost no difference between the ambient pressure and cabin pressure.

Typically in prior art devices, bleed air from the engines is used to increase the reference chamber pressure in this situation. This bleed air is also connected to a venturi vacuum ejector to create a lower pressure to decrease the reference chamber pressure when necessary on the ground. The present invention eliminates the need for using engine bleed air.

Each valve 12 is self-regulating having maximum safety limiting valves 30, 32. Safety valve 30 checks for maximum differential pressure and safety valve 32 checks for maximum equivalent cabin altitude. The limits for these valves are factory set and adjusted to the individual aircraft requirements. Typically, the altitude safety valve 32 is set from 13,000 to 15,000 feet to prevent the aircraft occupants from experiencing high altitude problems. The maximum differential pressure safety valve 30 is set so the pressure differential between the cabin and the ambient conditions does not exceed a limit specified by the aircraft manufacturer (typically from 8½ psi to 9½ psi) to prevent overstressing the structural integrity of the aircraft. The safety valves override any settings provided by the controller 10 to the outflow valves 12.

Optionally, manual toggle valve 14 (well known in the art) can be included which provides full manual control of cabin pressure in the event of electrical power failure. The valve 14 is typically a three-position valve with a return spring to center position which will supply static pressure (climb) or cabin (descent) pressure to the outflow valves 12.

As can be seen, all connections to valves 12 from controller 10 are pneumatic.

All control and communications interface with the aircraft is accomplished via the aircraft ARINC 429 electronic data bus via connection port 28. For convenience, the system also provides for a number of discrete electronic inputs, which may be used in place of the ARINC inputs at the discretion of the aircraft manufacturer. The ARINC interface is bi-directional, and the operation of the controller 10 is coupled very closely to the integrated aircraft Avionics system, all of which are well known in the art.

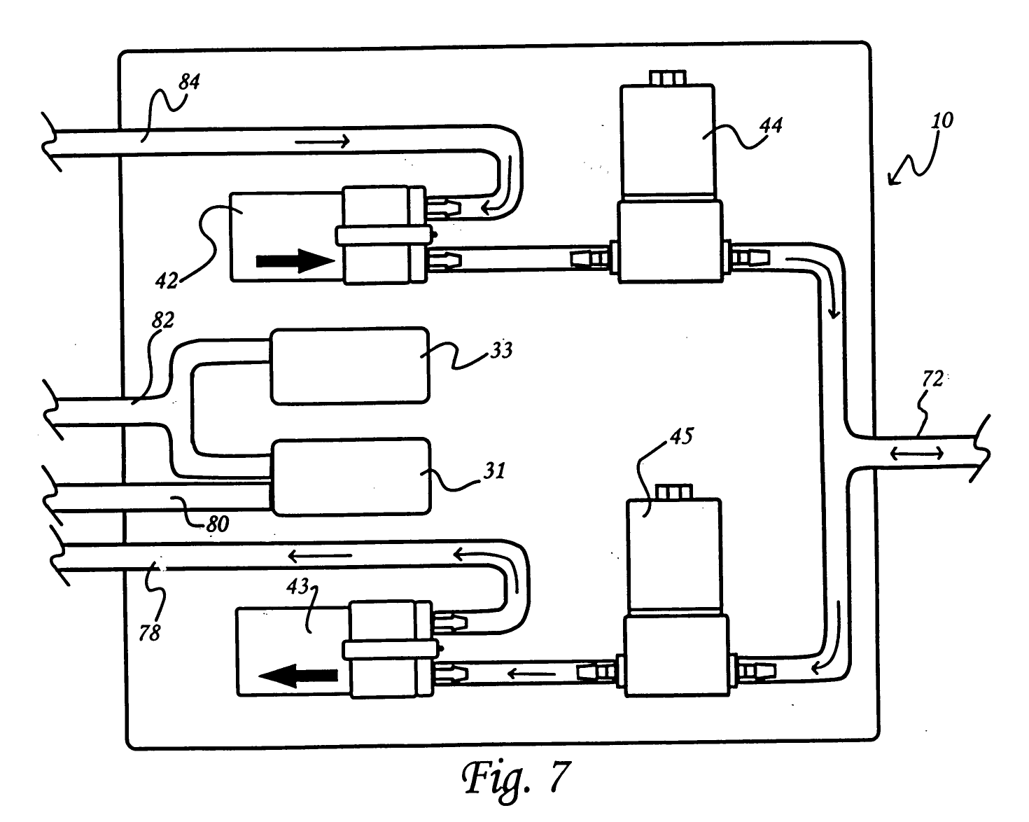

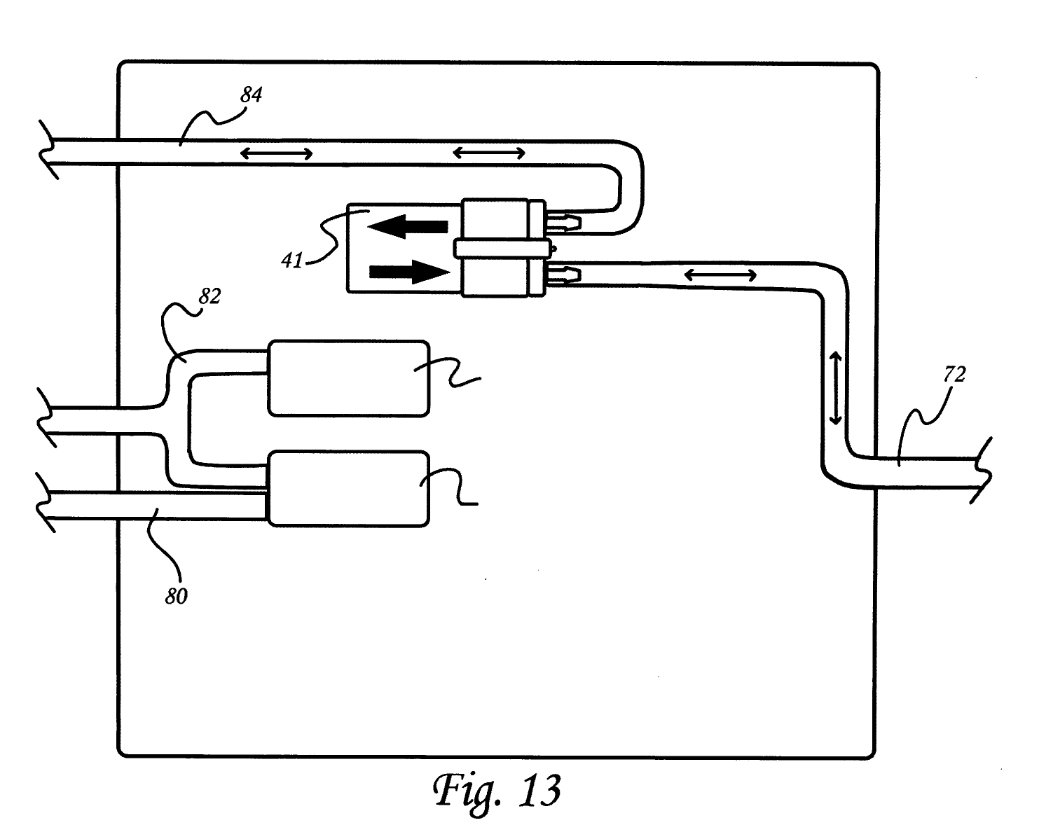

Controller 10 measures cabin pressure using its own internal transducer 33 as shown in FIGS. 7-13. The bi-directional ARINC interface provides both cabin pressure and cabin pressure rate outputs to the aircraft avionics system. In addition, the controller 10 has an internal pressure transducer 31, which is used to directly measure cabin differential pressure. This enables the controller to provide this information to the aircraft avionics system as well. In addition, the internal differential pressure transducer 31 allows the apparatus to maintain full autoschedule operation if the Aircraft ARINC 429 bus communication is lost. The need to fallback to isobaric control is therefore eliminated.

Outflow valves 12 are bolted to the cabin wall bulkhead 16 so that the open bottom grill is exposed to the outside of the aircraft. Housing 15 of controller 15 is attached inside of the cabin 18 of the aircraft wherever it is convenient. Nameplate 13 provides manufacturer information.

All the pressure lines shown are preferably ¼ tubing connected via ¼″ NPT fittings or barb-type fittings. Line 72 connected to fitting 38 provides airflow to the reference chamber 48. Line 80 measures the static pressure outside of the aircraft. Port 84 permits air to enter from the cabin. Port 82 measures the cabin air pressure. Line 78 permits airflow from the reference chamber 48 to exit the aircraft. The operation of valves 12 is discussed below.

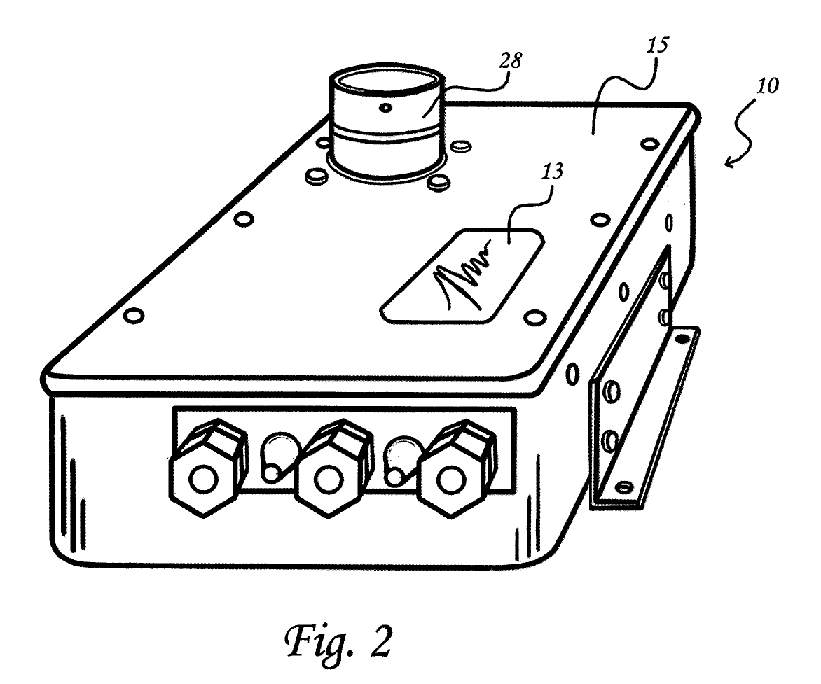

FIG. 2 shows an isometric view of the preferred embodiment of the housing 15 of controller 10. Controller 10 has an extremely small footprint, preferably measuring 6 inches by 6 inches and being about 3 inches high, thus making it easy to install virtually anywhere within the aircraft. Estimated weight is only about 2½ pounds.

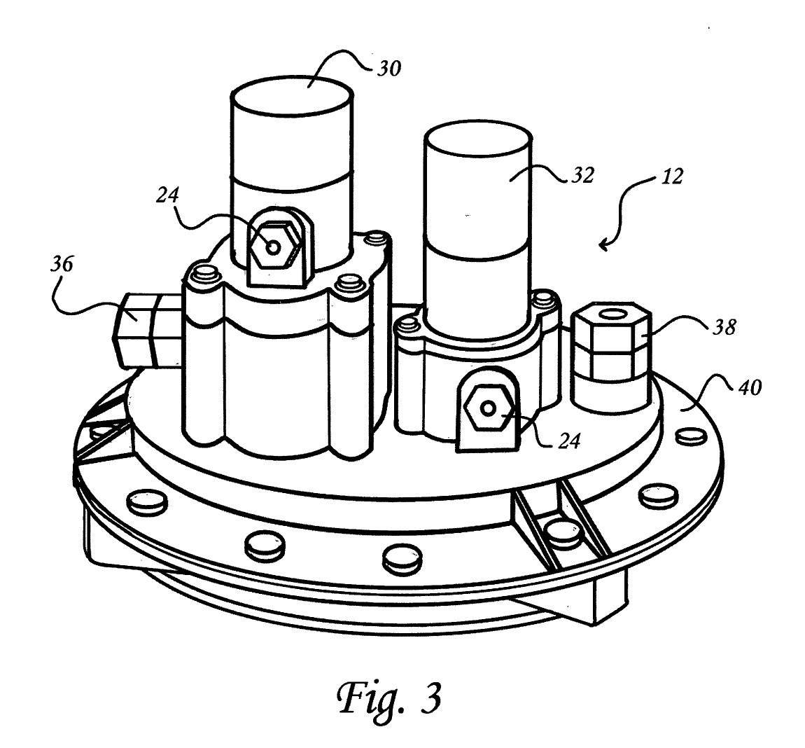

FIG. 3 depicts an isometric view of the preferred embodiment of an outflow valve. Similarly, these valves have a small footprint, being about 7 inches in diameter overall in one embodiment and only about 5½ inches high. Estimated weight of each outflow valve 12 is about 1¾ pounds. The overall grill diameter of the valves is chosen to match the expected maximum inflow rate of air provided to the cabin by the aircraft environmental control system. Smaller aircraft typically use a 3 inch diameter valve. Larger aircraft may require a 4 inch or larger diameter valves.

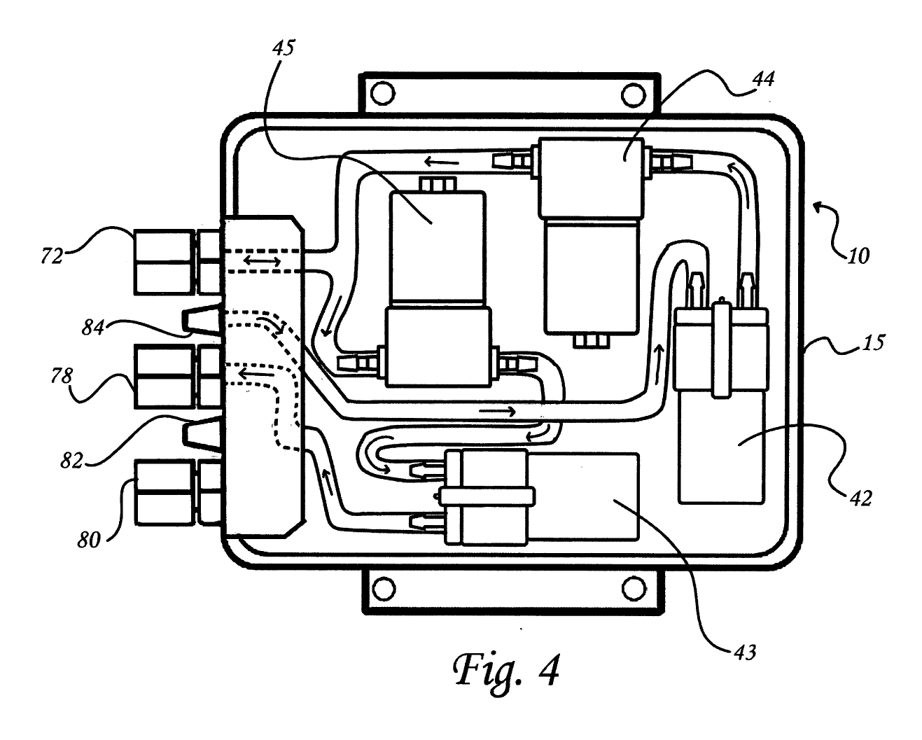

FIG. 4 is a top view of the controller 10 housing 15 with the cover removed showing the placement of the solenoids and miniature pumps in the preferred embodiment. The transducers 31, 33 as well as the pneumatic connections plus electronic circuit board and other electrical connections have been removed to more clearly illustrate how the tubing is connected between the fittings, solenoids 44, 45 and miniature pumps 42, 43. Also, note the arrows in the tubing indicates the direction of airflow when controller 12 in operation (discussed below).

The miniature pumps 42, 43 are used to provide the pneumatic control to the outflow valves 12 during periods when the cabin to static differential pressure is low, i.e. primarily take-off and landing. This saves the engines from having to supply service air, which allows higher thrust output during take-off. It also allows the outflow valve 12 to be commanded to full open without the engines, which reduces the bump associated with engine turn on with the doors closed. The plumbing associated with the service air is also eliminated; reducing aircraft design complexity and aircraft weight. Placing miniature pumps 42, 43 in the controller 10 reduces the number of pneumatic connections, reducing the risk of misconnected hoses and connector failures.

The automated switchover of pumped air to static or cabin air allows the pumps 42, 43 to be used for only short periods of time. The pumps 42, 43 are needed during ground testing of the system, during take-off, landing, decompression, and when the differential pressure between static and cabin air is below 0.2 in. Hg.

As shown, pumps 42, 43 are physically located next to the solenoids 44, 45 in the controller housing allowing the solenoids 44, 45 to heat the pumps 42, 43 and reduce the possibility of icing. As noted above, pumps 42, 43 are only turned on during take-off, final approach, ground test, and decompression. With a rated mean-time-before-fault (MTBF) of 10,000 hours of operation, assuming 4 flights per day, the calculated pump life would be greater than 70 years.

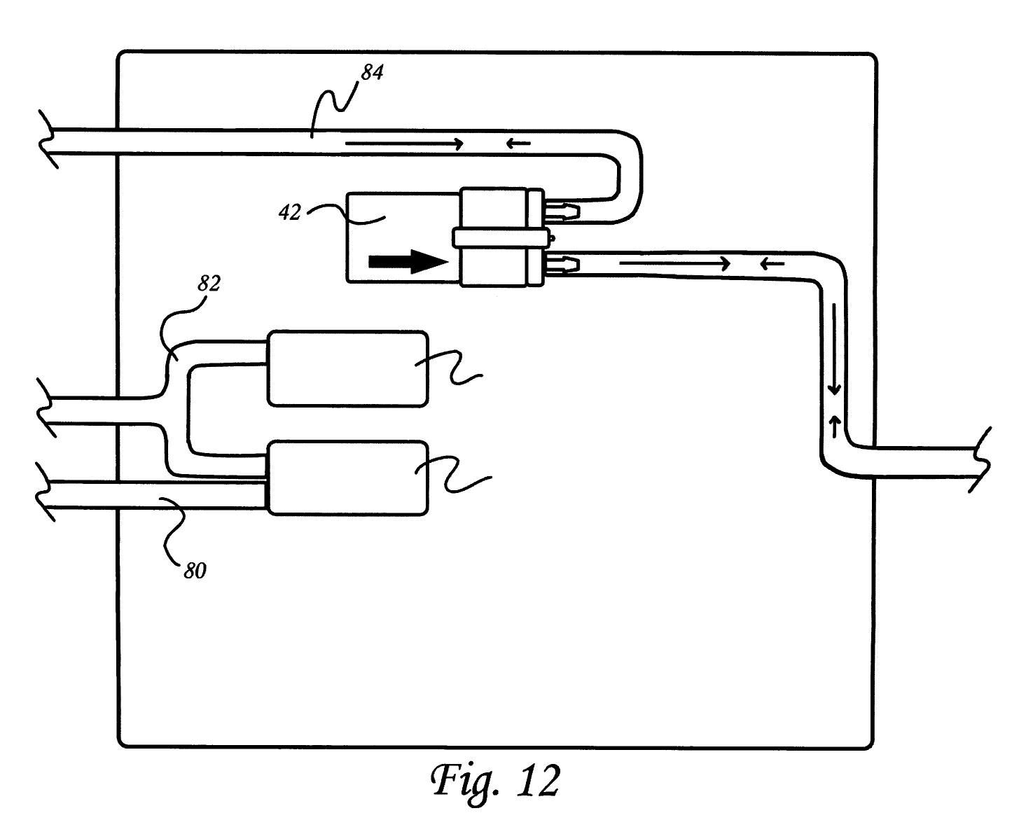

Pumps 42, 43 are preferably rotary vane pumps, such as made by Thomas Industries. However, any pumps than can generate more than 0.2 PSI pressure can be used. Maximum pump flow rate and the specific outflow valves used affect the maximum time for system pre-pressurization, which occurs at take-off. The pumps can also be a diaphragm pump (necessary in FIG. 12 embodiment), such as made by Thomas Industries. The pumps can be any combination of single or dual headed pumps such that only pressure or pressure and vacuum are generated. Any pump that can inflate or deflate the manifold is suitable.

The preferred solenoids 44, 45 are a 2-way normally closed configuration, such as sold by Precision Dynamics. Solenoids 44, 45 need to be able to open and close at least twice as fast as the bandwidth of the system control loop. Further, solenoids 44, 45 must be able to handle two times the maximum pressure seen by the pressurization control apparatus (1 Atmosphere). A three-way solenoid (not shown) may be used to replace the function of two solenoids. A three way solenoid has a lower reliability due to continual switching to modulate the manifold pressure. A four-way solenoid could also be used to replace the two 2-way solenoids, while maintaining the same pneumatic connections.

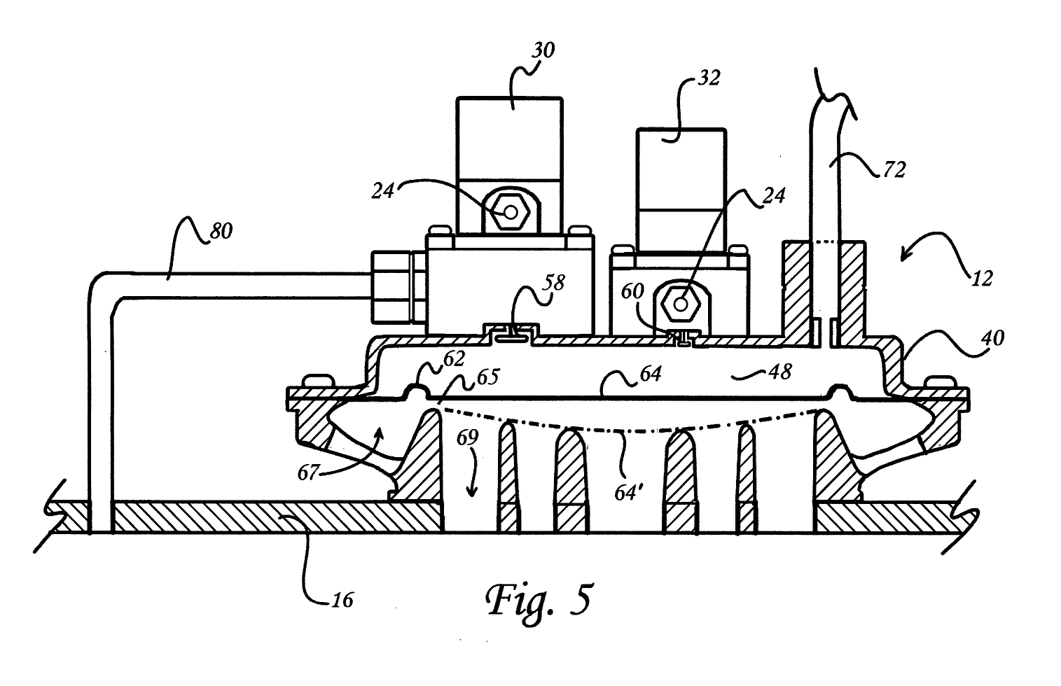

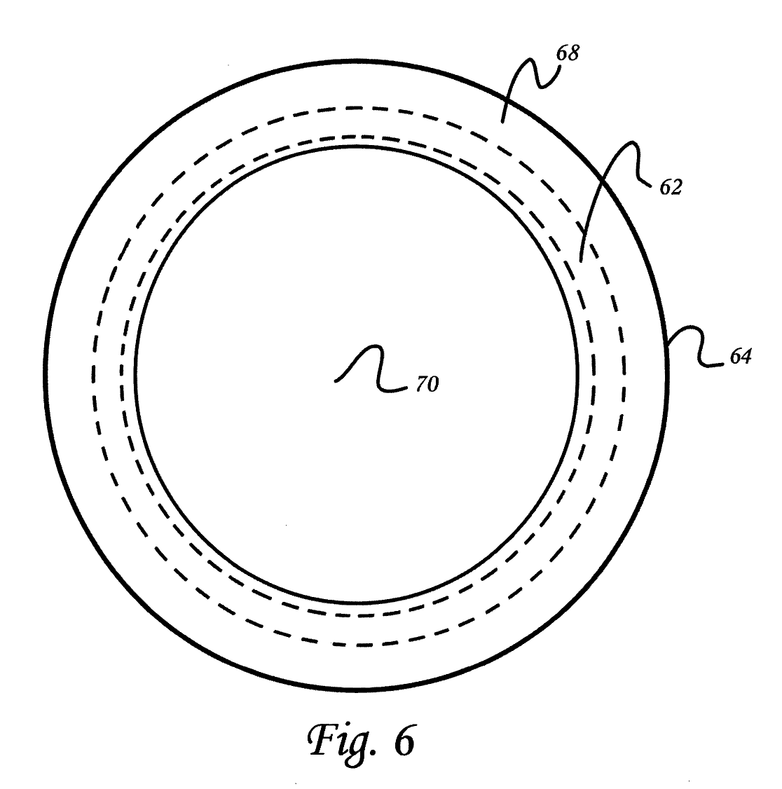

As shown in FIG. 5, the reference chamber 48 of outflow valve 12 is shown. When cabin 18 is pressurized during flight, the cabin 18 pressure is substantial greater than the outside pressure 20. Thus, diaphragm 64 preferably made from reinforced fluorosilicone covers a three-inch diameter outlet grill 74. The diaphragm 64 is larger than the grill by an amount that makes the annular area approximately equal to the grill area (See, FIG. 6). Cabin pressure pushes in direction 67 against the annular outer area of the diaphragm, trying to provide opening 65 of the outflow port; the lower pressure outside the aircraft structure (aircraft altitude) draws the diaphragm 64 against the grill (line 64′) trying to close the port.

Above the diaphragm 64 is a sealed reference pressure chamber 48. The air trapped in this chamber functions as the regulating “spring” which determines the operating point of the valve. Solenoid pilot valves and pumps in the controller 10 are modulated by the controller to change the reference chamber pressure. Changes in reference chamber pressure cause the diaphragm 64 to move, which either increases or decreases the outflow rate from the cabin, thereby changing the cabin pressure and altitude. A common pneumatic connection 72 between outflow valve reference chambers ensures balanced outflow between valves.

Each outflow valve 12 features an independent maximum differential pressure safety relief valve 30 connected to static pressure via line 80 and cabin pressure via port 24, and a maximum altitude safety limit valve 32 connected to the cabin pressure via port 24.

If the differential pressure becomes too great, spring adjusted plunger 58 changes the pressure in the reference chamber 48 to keep the aircraft operating within the prescribed limits. Similarly, if the maximum altitude pressure exceeds the limits, spring adjusted plunger 60 adjusts the reference chamber 48.

Isolation is provided between outflow valves 12 to prevent a single fault from disabling both maximum differential pressure valves. This is implemented via a 0.033 diameter restrictor orifice (not shown) at each of the outflow valve common ports. Together, these outflow valves meet all applicable regulations regarding maximum and negative differential pressure; no additional safety valves are required.

The forward pressure drop for a single outflow valve will not exceed 0.25 psid at 16 lb/min flow, which equates to 0.7 inches of water at 10 ppm for two outflow valves in parallel.

The grill 74 is TEFLON coated to avoid tobacco tar accumulation. Tar accumulation on the smooth fluorosilicone diaphragm is minimal. Should any foreign matter intrude into the grill-sealing surface, the flexible diaphragm 64 conforms to it and continues to operate normally. Field history for the apparatus shown reveals that the grill 74 does not create objectionable noises during operation. The grill 74 has a 3.5″ diameter bolt circle for aircraft bulkhead mounting.

FIG. 6 is an illustration of the surface area of the diaphragm 64 showing the cabin annular area 68 relative to the ambient annular area 70. Rib 62 is provided to help stiffen diaphragm 64 so that it can more effectively provide seal 65. Area 68 is equal to area 70 so that the pressure within reference chamber 48 is the midpoint (numerical average) of the cabin pressure and the ambient pressure.

As shown in FIG. 7, which depicts the preferred embodiment, pump 42 is connected in series with solenoid 44. The input to pump 42 is connected to line 84 which in turn is connected to the cabin of the aircraft. The output of solenoid 44 is connected to line 72 which is connected to the reference chamber 48 of the outflow valve assembly 12. Pump 42 pumps air from the cabin to pressurize the reference chamber 48.

Pump 43, also connected in series with the solenoid 45 enables reference chamber 48 to be deflated via line 72 through static pressure line 78 which exits the aircraft.

During flight, pumps 42 and 43 are not used. Solenoid 44 which is connected to the cabin air is used during descent and solenoid 45 which is connected to the ambient air is used during climbing. Recall that the pressure in reference chamber 48 is the midpoint (numerical average). Thus, if the plane is descending, the ambient pressure is increasing and the reference chamber pressure must also increase so that the reference pressure is midpoint between the cabin pressure and ambient pressure. Similarly, if the plane is climbing, the ambient pressure is decreasing and reference pressure must also decrease correspondingly so that air in the reference chamber is permitted to exit the aircraft via pressure line 78. In this manner, the electronic circuitry of controller 10 modulates the opening and closing of solenoids 44 and 45 to maintain cabin pressure within the prescribed operating envelope.

Note that air is constantly being brought into the cabin via the environmental air control system (not shown) to provide a supply of fresh air in the cabin. Thus, outflow valve assembly 12 is never fully closed during flight.

When the aircraft is on the ground or landing, the pressure differential across diaphragm 64 is insufficient to provide the degree of control necessary. The solenoid 44, 45 merely function as “on or off” switches and passively regulate airflow due to the pressure gradient between cabin and ambient outside air.

Thus, pump 42 raises the pressure in reference chamber 48 and pump 43 lowers the pressure in reference chamber 48. Solenoid 44 must be open when pump 42 is on and solenoid 45 must be closed. This is the landing mode. Similarly, solenoid 45 must be open when pump 43 is on and solenoid 44 must be closed. This is the take off mode.

When the aircraft is on the ground and powered and controller 10 senses that a take-off sequence has been initiated, pre-pressurization of the cabin commences to an altitude of 200 feet below the present altitude and completes in 30 seconds. This is accomplished by activating pump 43 increasing the pressure in the reference chamber 48.

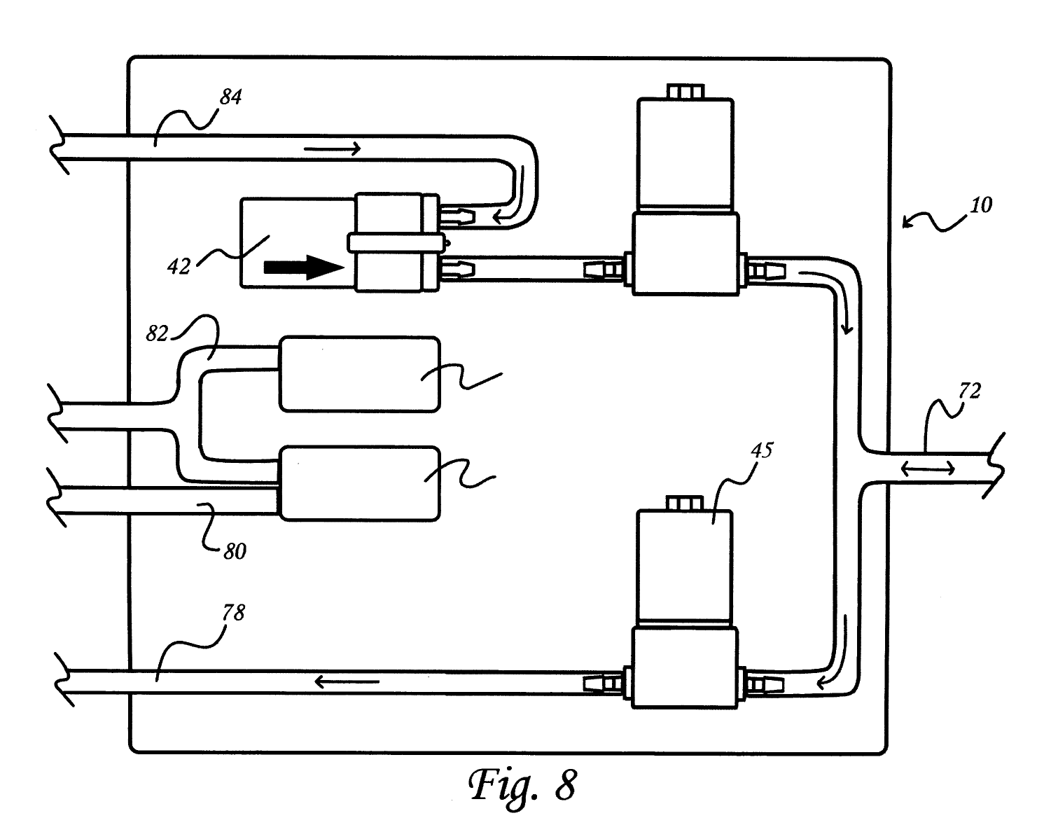

As shown in FIG. 8, an alternative embodiment uses only pump 42. Solenoids 44, 45 operate the same as shown in FIG. 7. Thus, active flow of air (provided by a pump) due to controller 10 is only possible during descent. While this configuration does not provide the degree of control present in the preferred embodiment, this arrangement is acceptable.

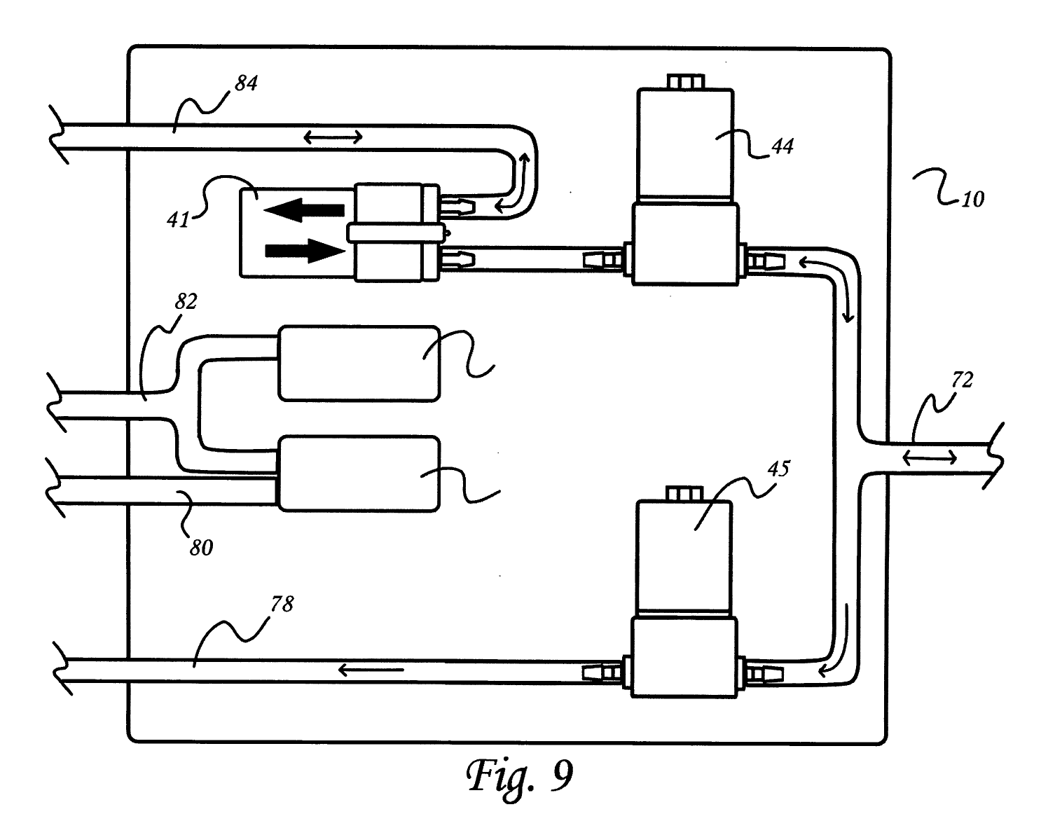

FIG. 9 depicts still another embodiment using a single reversible pump 41 on the “cabin” (descent) side of controller 10. Again, solenoids 44, 45 work the same as in the previous embodiments. Using a reversible pump 41 enables air to be pumped into and out of reference chamber 48 so that both take-off and landing pressurization control is more effectively provided. However, the use of single pump does not provide the redundancy obtained with separate descent and climb pumps.

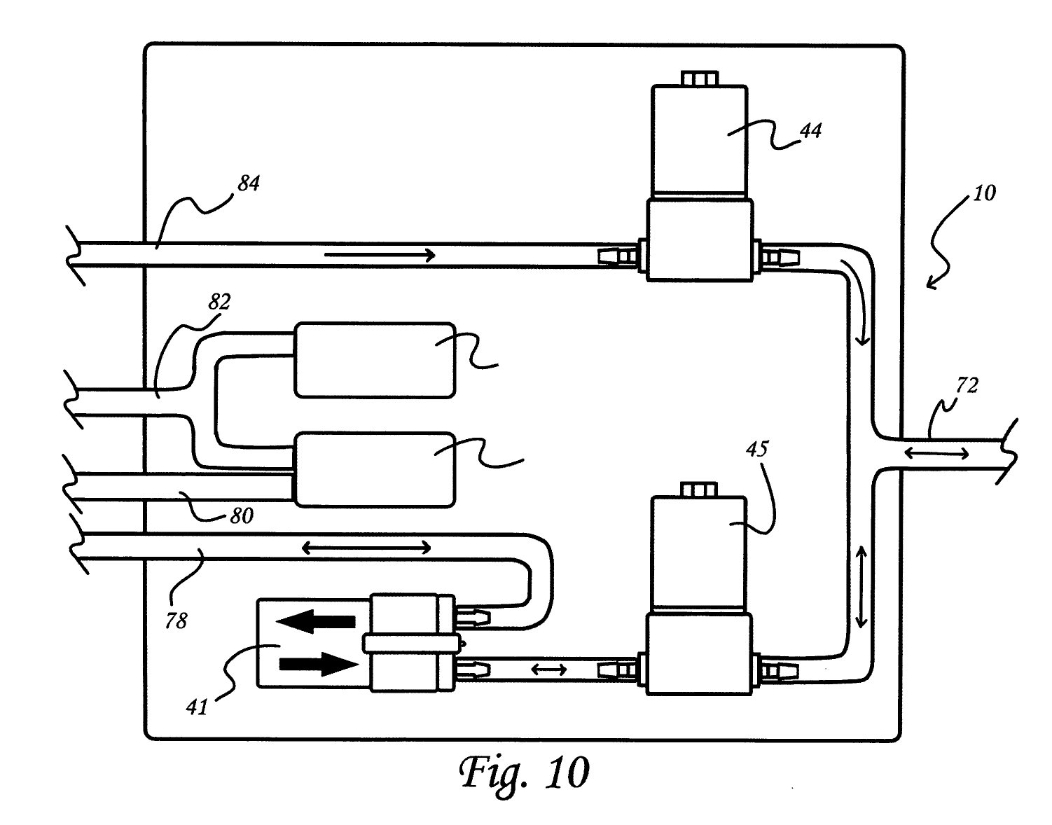

FIG. 10 is a variation of the embodiment shown in FIG. 9, only the reversible pump 41 is placed on the “ambient” (climb) side of controller 10. As before, the solenoid operation is the same.

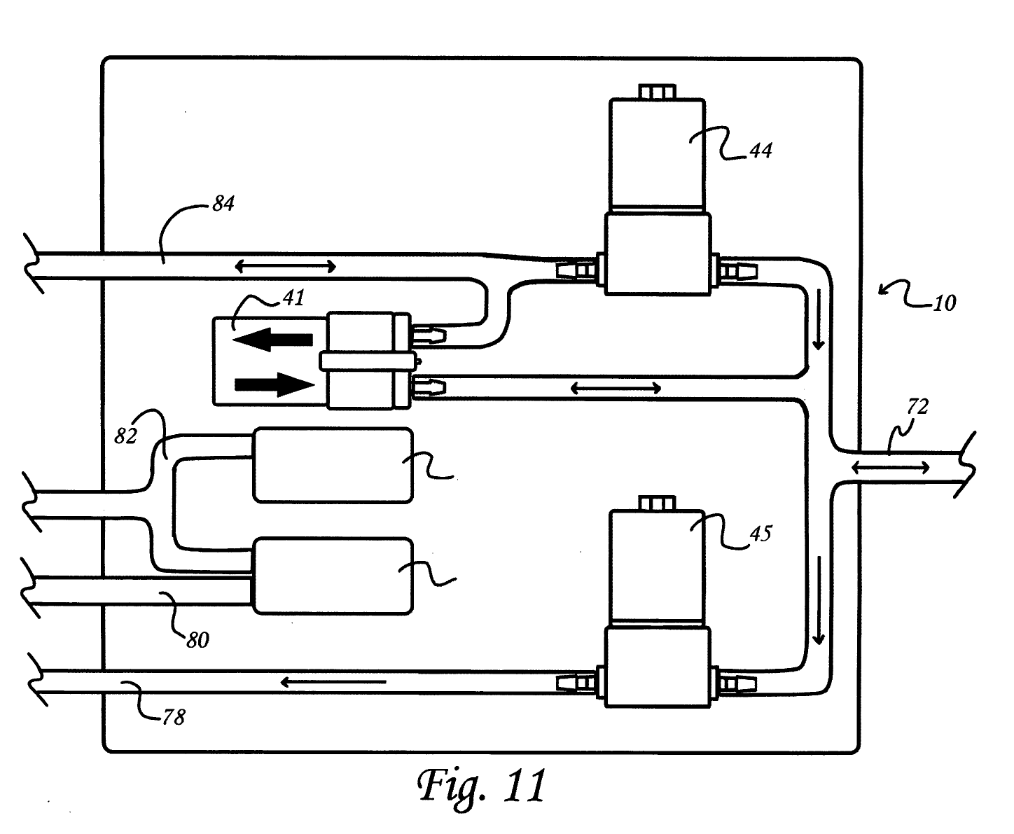

FIG. 11 shows still another location for pump 41. In this embodiment, both solenoids 44 and 45 are closed when pump 41 is pressurizing reference chamber 48. When deflating reference chamber 48, solenoids 44, 45 are also closed. Pump 41 when deflating chamber 48 must pump against a pressure gradient as the cabin pressure is going to be higher than the reference chamber pressure.

FIG. 12 shows an embodiment that utilizes just a single pump 42 without the use of solenoids. In this embodiment, pump 42 must be a vane pump so that when pump 42 is turned off, air can escape (small arrows in line 84) from reference chamber 48. Note that only limited control is possible during take-off until the ambient pressure is sufficiently low to provide a pressure gradient from inside to outside of the cabin.

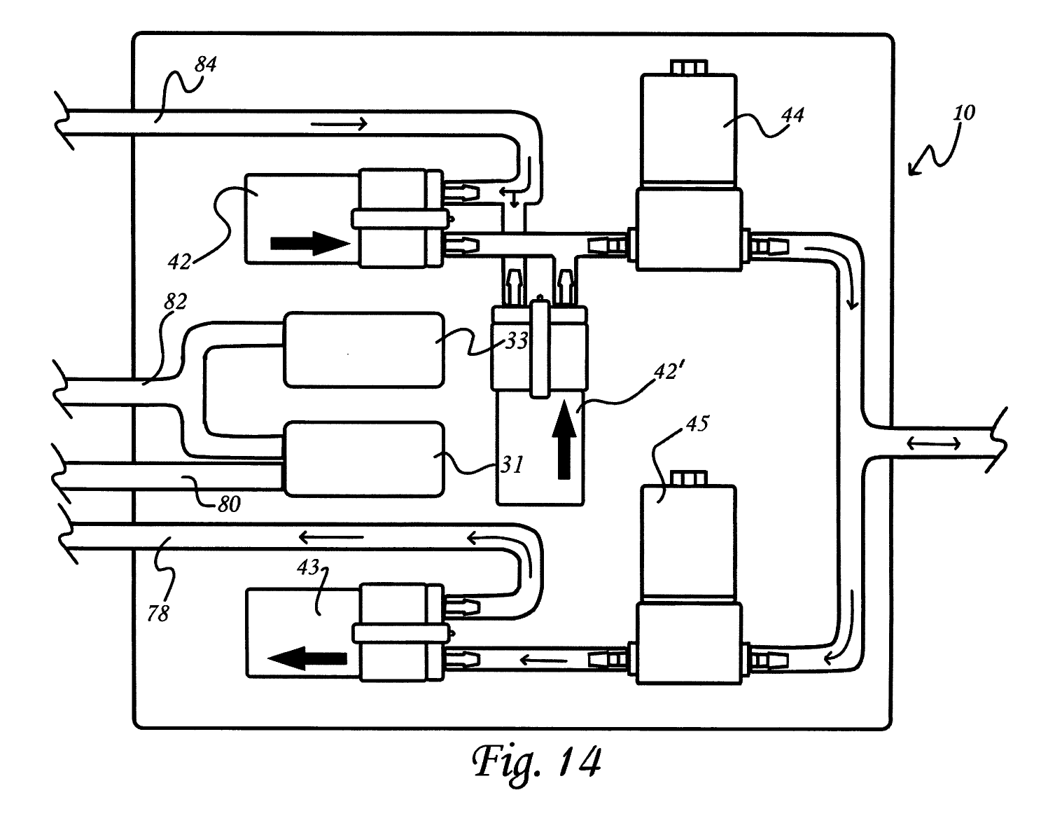

This embodiment is similar to that shown in FIG. 12 only a single reversible pump 41 replaces pump 42. In this configuration, both ascent and descent, take-off and landing control is provided. However, pump 41 must be working constantly so that the reliability of this embodiment is less than the preferred embodiment. Further, this embodiment lacks the redundancy of parts provided with the preferred embodiment. The embodiment shown illustrated in FIG. 14 shows two pumps, 42 and 42′ connected in parallel in order to increase the maximum flow rates from the cabin to said reference chamber 48.

While certain representative embodiments of the invention have been described herein for the purposes of illustration, it will be apparent to those skilled in the art that modification therein may be made without departure from the spirit and scope of the invention.

What is claimed is:

1. A cabin pressure control apparatus for automatically regulating the pressure of an aircraft, said apparatus comprising:
a reference chamber independent of any bleed air from the aircraft engines which is customarily used in adjusting the air pressure within said reference chamber;
at least one miniature pump pneumatically connected to said reference chamber wherein said at least one miniature pump is used to inflate or deflate said reference chamber.

2. The cabin pressure control apparatus of claim 1 further comprising at least one solenoid that is pneumatically connected to its corresponding said at least one miniature pump for inflating

3. The cabin pressure control apparatus of claim 2 wherein one of said at least one miniature pump is an inflation pump and its corresponding solenoid are pneumatically connected to the aircraft cabin and another of said at least one miniature pump is deflation pump and its corresponding solenoid are pneumatically connected to the ambient air outside the aircraft.

4. A cabin pressure control apparatus of claim 1 wherein said apparatus is fully compatible with existing cabin pressure control apparatus manufacture by Kollsman, Inc.

5. The cabin pressure control apparatus of claim 1 wherein said reference chamber further comprises a diaphragm that is supported by a grill wherein the diaphragm is larger than the grill by an amount that makes the annular area of said diaphragm approximately equal to the annular area of said grill.

6. The cabin pressure control apparatus of claim 1 wherein one miniature pump is an inflation pump and the other miniature pump is a deflation pump and wherein said inflation pump is connected in series with a first solenoid to inflate said reference chamber and wherein said deflation pump is connected in series with a second solenoid to deflate said reference chamber such that the air used to inflate the reference chamber comes from the air in the cabin of the aircraft and wherein the air that deflates the reference chamber exits the aircraft.

7. The pump pressure control apparatus of claim 6 wherein the inflation and deflation pumps are not used during flight and wherein the first solenoid is used during descent and the second solenoid is used during climbing, thus the opening and closing of the first and second solenoid maintains cabin pressure in the prescribed operating envelope.

8. The pump pressure control apparatus of claim 7 such that when the aircraft is on the ground or landing, there is insufficient pressure differential across the diaphragm said reference chamber to provide the degree of control necessary, thus the inflation pump is used to increase the pressure in said reference chamber and the deflation pump is used to lower the pressure in said reference chamber in concert with the opening and closing of the first and second solenoid wherein the degree of control is provided.

9. The pump pressure control apparatus of claim 8 wherein said first solenoid must be open when the inflation pump is ‘on’ and said second solenoid must be closed in order to provide a ‘landing’ mode and wherein correspondingly, the second solenoid must be ‘open’ when the deflation pump is ‘on’ and the first solenoid must be ‘closed’ in order to provide a ‘takeoff’ mode.

10. A cabin pressure control apparatus for automatically regulating the pressure of an aircraft, said apparatus comprising;
a reference chamber independent of the bleed air from the aircraft engines which is customarily used in adjusting the air pressure within said reference chamber;
one miniature pump connected to said reference chamber is used to deflate or inflate said reference chamber and;
first and second solenoid that function as a switch to either allow air into said reference chamber or out of said reference chamber.

11. The pump pressure control apparatus of claim 10 wherein said one miniature pump is a reversible pump that is placed on the cabin (descent side) of said apparatus.

12. The pump pressure control apparatus of claim 11 wherein said reversible pump is placed on the ambient (climb side) of said apparatus instead of on the cabin (descent side) of said apparatus as claimed in claim 11.

13. The pump pressure control apparatus of claim 11 wherein said single reversible pump must run continuously during ‘takeoff’ and ‘landing.’

14. A cabin pressure control apparatus comprising a reference chamber and a vane pump such that when said vane pump is turned ‘off’, air can escape from said reference chamber.

15. The cabin pressure control apparatus of claim 6 wherein two of said miniature pumps are inflation pumps connected together in parallel and the third pump of said miniature pumps is a deflation pump and wherein said parallel inflation pumps are connected in series with a first solenoid to inflate said reference chamber and wherein said deflation pump is connected in series with a second solenoid to deflate said reference chamber such that the air used to inflate the reference chamber comes from the air in the cabin of the aircraft and wherein the air that deflates the reference chamber exits the aircraft.
